(19) United States
(12) Patent Application Publication
(10) Pub. No.: US 2025/0142281 A1
(43) Pub. Date: May 1, 2025

(54) DELAY PROCESSING IN AUDIO RENDERING

(71) Applicant: Fraunhofer-Gesellschaft zur Förderung der angewandten Forschung e.V., München (DE)

(72) Inventors: Sascha DISCH, Erlangen (DE); Vensan MAZMANYAN, Erlangen (DE); Marvin TRÜMPER, Erlangen (DE); Matthias GEIER, Erlangen (DE); Jürgen HERRE, Erlangen (DE); Christof FALLER, Greifensee (CH); Markus SCHMIDT, Lausanne (CH)

(73) Assignee: Fraunhofer-Gesellschaft zur Förderung der angewandten Forschung e.V., München (DE)

(21) Appl. No.: 19/007,446

(22) Filed: Dec. 31, 2024

Related U.S. Application Data
(63) Continuation of application No. PCT/EP2023/068831, filed on Jul. 7, 2023.

(30) Foreign Application Priority Data
Jul. 12, 2022 (EP) 22184526.6

(51) Int. Cl. H04S 7/00; H04R 5/02

(52) U.S. Cl. CPC H04S 7/303; H04R 5/02; H04S 7/307; H04S 2400/11; H04S 2400/13

(57) ABSTRACT

Audio processor for performing audio rendering by generating rendering parameters, which determine a derivation of loudspeaker signals to be reproduced by a set of loudspeakers from an audio signal. The audio processor is configured to perform a delay processing so as to determine, based on a listener position, delays for generating the loudspeaker signals for the loudspeakers from the audio signal. Further, the audio processor is configured to control the delay processing by modifying a version of the listener position, based on which the delay processing is commenced, or any intermediate value determined by the delay processing based on the listener position so as to reduce artifacts in the audio rendition due to changes in the delays.

### CROSS-REFERENCES TO RELATED APPLICATIONS

This application is a continuation of copending International Application No. PCT/EP2023/068831, filed Jul. 7, 2023, which is incorporated herein by reference in its entirety, and additionally claims priority from European Application No. EP 22 184 526.6, filed Jul. 12, 2022, which is incorporated herein by reference in its entirety.

Embodiments according to the invention relate to an audio processor, a system, a method and a computer program for audio rendering, such as, for example, a user adaptive loudspeaker rendering using a tracking device.

### BACKGROUND OF THE INVENTION

A general problem in audio reproduction with loudspeakers is that usually reproduction is optimal only within one or a small range of listener positions. Even worse, when a listener changes position or is moving, then the quality of the audio reproduction highly varies. The evoked spatial auditory image is unstable for changes of the listening position away from the sweet-spot. The stereophonic image collapses into the closest loudspeaker.

This problem has been addressed by previous publications, including [1] by tracking a listener's position and adjusting gain and delay to compensate deviations from the optimal listening position. [2] shows an extension on how to adapt also to the spatial radiation characteristics of the used loudspeakers. Listener tracking has also been used with cross talk cancellation (XTC), see, for example, [3]. XTC requires extremely precise positioning of a listener, which makes listener tracking almost indispensable.

Previous methods for listener position controlled delay adjustment/compensation for loudspeaker signals assume both smooth and precise tracking data to control the variable delay line (VDL) to adjust the loudspeaker signal delay. However, in practice, listener movement might be highly dynamic and may contain abrupt direction changes. Additionally, position data acquisition might be impaired by tracking errors, time jitter and too slow or irregular position update rates.

Therefore, it is desired to devise a concept which involves a delay adjustment scheme that is robust and able to account for highly dynamic or non-precise tracking data input minimizing perceptual artifacts due to dynamic delay adjustment.

This object is achieved by the subject matter of the independent claims.

Advantageous embodiments are the subject of dependent claims.

### SUMMARY

An embodiment may have an audio processor for performing audio rendering by generating rendering parameters, which determine a derivation of loudspeaker signals to be reproduced by a set of loudspeakers from an audio signal, configured to perform a delay processing so as to determine, based on a listener position, delays for generating the loudspeaker signals for the loudspeakers from the audio signal, wherein the audio processor is configured to control the delay processing by modifying a version of the listener position, based on which the delay processing is commenced, or any intermediate value determined by the delay processing based on the listener position so as to reduce artifacts in the audio rendition due to changes in the delays.

Another embodiment may have a method for audio rendering by generating rendering parameters, which determine a derivation of loudspeaker signals to be reproduced by a set of loudspeakers from an audio signal, the method comprising performing a delay processing so as to determine, based on a listener position, delays for generating the loudspeaker signals for the loudspeakers from the audio signal, controlling the delay processing by modifying a version of the listener position, based on which the delay processing is commenced, or any intermediate value determined by the delay processing based on the listener position so as to reduce artifacts in the audio rendition due to changes in the delays.

Another embodiment may have a non-transitory digital storage medium having a computer program stored thereon to perform the method for audio rendering by generating rendering parameters, which determine a derivation of loudspeaker signals to be reproduced by a set of loudspeakers from an audio signal, the method comprising performing a delay processing so as to determine, based on a listener position, delays for generating the loudspeaker signals for the loudspeakers from the audio signal, controlling the delay processing by modifying a version of the listener position, based on which the delay processing is commenced, or any intermediate value determined by the delay processing based on the listener position so as to reduce artifacts in the audio rendition due to changes in the delays, when said computer program is run by a computer.

Another embodiment may have a bitstream (or digital storage medium storing the same) as mentioned in the inventive audio processor.

It has been found that smooth and precise tracking data of a listener to control the variable delay line (VDL) is not always available. However, delays determined based on a less than optimal listener position information may result in artifacts in the audio rendition. Therefore, it is the objective of this invention to provide a perceptually high quality delay adjustment/compensation that considers the fact that real-world listener movement might be highly dynamic and may contain abrupt direction changes and that position data acquisition might be impaired by tracking errors, time jitter and slow position update rates. This difficulty is overcome by using, at a delay processing, a modified version of the listener position or a modified intermediate value determined by the delay processing. It is an idea of the underlying embodiments of the present invention that modifying, like controlling, limiting, smoothing, or scaling, input listener tracking data—or derived values—may be performed to avoid artifacts in the adaptive rendering. This is based on the realization that the modification may reduce a variability/noisiness of listener position information or of delays determined based on the listener information. The control of the delay processing using the modification avoids or at least reduces too fast and erroneous changes in delays and thus reduces artifacts even for very critical sound material like tonal sounds (sine tones with high frequency, pitch pipe, glockenspiel). This enables listener adaptive delay processing even for real-world listener movement with highly dynamic and abrupt direction changes of the listener. Thus, the listener can move within a large “sweet area” (rather than a sweet spot) and experience a stable sound stage in this large area when listening to sounds reproduced by a set of loudspeakers based on signals or parameters obtained by the controlled delay processing.

Accordingly, an embodiment relates to an audio processor for performing audio rendering by generating rendering parameters, which determine a derivation of loudspeaker signals to be reproduced by a set of loudspeakers from an audio signal. The audio processor is configured to perform a delay processing so as to determine, based on a listener position, delays for generating the loudspeaker signals for the loudspeakers from the audio signal. For example, each delay determined by the delay processing may be associated with one of the loudspeakers, e.g., the audio processor may be configured to determine for each loudspeaker a delay dependent on which the respective loudspeaker signal can be derived. Further, the audio processor is configured to control the delay processing by modifying a version of the listener position, based on which the delay processing is commenced, or any intermediate value determined by the delay processing based on the listener position so as to reduce artifacts in the audio rendition due to changes in the delays.

The version of the listener position may be modified by adapting, smoothing, clipping or scaling a version of the listener position, e.g. the coordinates of the listener, distances of the listener to one or more loudspeakers of the set of loudspeakers, a velocity of the listener, an acceleration of the listener or a position change between a previous listener position and the current listener position.

Any intermediate value determined by the delay processing based on the listener position may be modified by adapting, smoothing, clipping or scaling the intermediate value. The intermediate value may be an intermediate delay value. For example, for a loudspeaker of the set of loudspeakers, a distance between the listener and the loudspeaker may be computed and the distance may then be converted into the intermediate delay value. Alternatively, the intermediate value may be a temporal rate of change of a delay, e.g., of the intermediate delay value, or a change rate of the temporal rate of change of the delay, e.g., of the intermediate delay value.

The listener position may be defined by coordinates indicating a position of a listener within a reproduction space, e.g. a position of the body of the listener, of the head of the listener or of the ears of the listener, e.g., tracking data. The listener position, for example, may be described in cartesian coordinates, in spherical coordinates or in cylindrical coordinates. Alternative to an absolute position of the listener, it is possible that the listener position indicates a relative position of the listener, e.g. relative to a reference loudspeaker of the set of loudspeakers or relative to each loudspeaker of the set of loudspeakers or relative to a sweet spot within the reproduction space or relative to any other predetermined position within the reproduction space.

A listener's velocity, a listener's acceleration, a temporal rate of change of the distance of the listener position to one or more of the set of loudspeakers, and a change rate of the temporal rate of change of the distance of the listener position to one or more of the set of loudspeakers may represent versions of the listener position.

The sweet spot may describe a focal point between the loudspeakers, where the listener can perceive the sound reproduced by the loudspeakers, e.g., the way it was intended to be heard by a mixer. The sweet spot may define a position within a reproduction space at which all wave fronts emitted by the set of loudspeakers arrive simultaneously. The sweet spot may alternatively be referred to as reference listening point.

According to an embodiment, the audio processor is configured to perform the control of the delay processing by subjecting one or more of
the listener position,
a listener's velocity,
the listener's velocity towards one or more of the set of loudspeakers,
a listener's acceleration,
the listener's acceleration towards one or more of the set of loudspeakers,
a distance of the listener position to one or more of the set of loudspeakers,
a temporal rate of change of the distance of the listener position to one or more of the set of loudspeakers,
a change rate of the temporal rate of change of the distance of the listener position to one or more of the set of loudspeakers,
the delay for one or more of the set of loudspeakers,
a temporal rate of change of the delay for one or more of the set of loudspeakers, and
a change rate of the temporal rate of change of the delay for one or more of the set of loudspeakers,
   to one or more of
smoothing
clipping, and
scaling with a monotonically increasing function having monotonically decreasing slope.
   For example, the version of the listener position may be modified by smoothing, clipping, and/or scaling the listener position, a listener's velocity, the listener's velocity towards one or more of the set of loudspeakers, a listener's acceleration, the listener's acceleration towards one or more of the set of loudspeakers, a distance of the listener position to one or more of the set of loudspeakers, a temporal rate of change of the distance of the listener position to one or more of the set of loudspeakers, and/or a change rate of the temporal rate of change of the distance of the listener position to one or more of the set of loudspeakers. The intermediate value determined by the delay processing based on the listener position may be modified by smoothing, clipping, and/or scaling a delay, e.g. an intermediate delay value, for one or more of the set of loudspeakers, a temporal rate of change of the delay for one or more of the set of loudspeakers, and/or a change rate of the temporal rate of change of the delay for one or more of the set of loudspeakers.

Such modifications enable to limit or control abrupt and/or erroneous changes of the listener position or of delays. The smoothing, for example, may be applied to the listener position, wherein the listener position may be defined by tracking data. Thus, the smoothing reduces, for example, tracking errors and time jitter and enables to obtain smooth position data even at slow position update rates. The clipping, for example, restricts or limits values, so that abrupt changes are limited. For example, a listener's velocity or listener's acceleration may be clipped, so that the listener's velocity or the listener's acceleration does not exceed a threshold. This reduces also dynamic delay adjustments determined based on the listener position and therefore possible artifacts due to too fast delay changes. Same applies to a clipping of a temporal rate of change of the distance of the listener position to one or more of the set of loudspeakers or of a change rate of the temporal rate of change of the distance of the listener position to one or more of the set of loudspeakers. The threshold may correspond to a value at which a pitch shift caused by a too fast listener movement or instantaneous change in listener movement is perceivable by the listener. Further it is possible to directly clip the delay for one or more of the set of loudspeakers, a temporal rate of change of the delay for one or more of the set of loudspeakers, or a change rate of the temporal rate of change of the delay for one or more of the set of loudspeakers, so that phase modulations caused by the delays are restricted/reduced. Additionally or alternatively, the scaling, for example, may be applied to reduce or dampen values, especially, values related to a fast change of a listener position or to a fast change of delays. The usage of a monotonically increasing function having monotonically decreasing slope at the scaling enables to scale high values more than small values. Therefore, high changes or fast changes are scaled more than small or slow changes, wherein the monotonically decreasing slope enables to scale high velocities, accelerations, delays, a temporal rate of change of the delay or a change rate of the temporal rate of change of the delay substantially more than small velocities, accelerations, delays, a temporal rate of change of the delay or a change rate of the temporal rate of change of the delay. This allows an advantageous reduction of artifacts. Optionally, clipping and scaling may be combined, for example, the values may be first scaled and in case the scaled value still exceeds a threshold, the scaled value may be clipped. Optionally, smoothing may be combined with clipping and or scaling, e.g., by smoothing the listener position and then scaling and/or clipping the smoothed listener position or a value derived therefrom. Alternatively, it is also possible to first scale and/or clip a value and then smooth the scaled and/or clipped value, e.g., compared to previous values, e.g. so that a smooth transition from a previous value to the current value is obtained.

According to an embodiment, the audio processor is configured to control the delay processing depending on control information and perform the modifying depending on the control information.

According to an embodiment, the audio processor is configured to derive from control information one or more of information on an intensity of the smoothing, information on a clipping threshold for the clipping and information on a parametrization of the monotonically increasing function having monotonically decreasing slope. This optimizes an artifact reduction, since the delay processing can be controlled individually for different environments and loudspeaker setups, since the control information can be provided for each environment or loudspeaker setup individually.

A further embodiment relates to a method for audio rendering by generating rendering parameters, which determine a derivation of loudspeaker signals to be reproduced by a set of loudspeakers from an audio signal. The method comprises performing a delay processing so as to determine, based on a listener position, delays for generating the loudspeaker signals for the loudspeakers from the audio signal. Further the method comprises controlling the delay processing by modifying a version of the listener position, based on which the delay processing is commenced, or any intermediate value determined by the delay processing based on the listener position so as to reduce artifacts in the audio rendition due to changes in the delays.

A further embodiment relates to a computer program or digital storage medium storing the same. The computer program has a program code for instructing, when the program is executed on a computer, the computer to perform one of the herein described methods.

A further embodiment relates to a bitstream or digital storage medium storing the same, as mentioned herein. The bitstream, for example, may comprise the control information and/or the audio signal and/or the rendering parameters and/or the delays and/or the listener position and/or the loudspeaker signals and/or the audio signal.

The method, the computer program and the bitstream as described herein are based on the same considerations as the herein-described audio processor. The method, the computer program and the bitstream can, by the way, be completed with all features and/or functionalities, which are also described with regard to the audio processor.

### BRIEF DESCRIPTION OF THE DRAWINGS

Embodiments of the present invention will be detailed subsequently referring to the appended drawings, in which:

FIG. 1 shows a schematic view of an embodiment of an audio processor determining gains and delays;

FIG. 2 shows a schematic view of an embodiment of amplitude panning;

FIG. 3 shows a schematic view of an embodiment of an audio processor configured for delay adjustment;

FIG. 4 shows a level 1 processing system as an example for a herein described audio processor;

FIG. 5 shows an example for a roll-off gain compensation function,

FIG. 6 shows exemplarily a code snippet of an initialization stage;

FIG. 7 shows exemplarily a code snippet of a release stage:

FIG. 8 shows exemplarily a code snippet of the reset stage;

FIGS. 9a to 9i show exemplary code snippets of a real-time parameters update stage; and

FIGS. 10a to 10c show exemplarily code snippets of an audio processing stage;

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

In the following, various examples are described which may assist in achieving a more effective compression when using listener position controlled gain and/or delay adjustment. The gain adjustment and/or the delay adjustment may be added to other parameter adjustments for sound rendition, for instance, or may be provided exclusively.

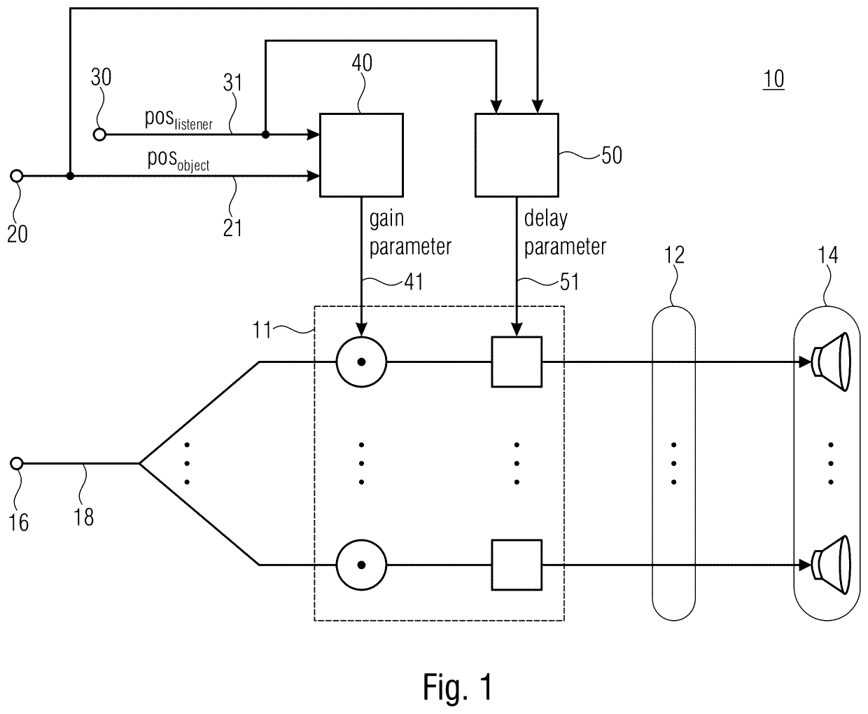

In order to ease the understanding of the following examples of the present application, the description starts with a presentation of a possible apparatus fitting thereto into which the subsequently outlined examples of the present application could be built. The following description starts with a description of an embodiment of an apparatus for generating loudspeaker signals for a plurality of loudspeakers. More specific embodiments are outlined herein below along with a description of details which may, individually or in groups, apply to the apparatus of FIG. 1.

The apparatus of FIG. 1 is generally indicated using reference sign 10 and is for generating loudspeaker signals 12 for a plurality of loudspeakers 14 in a manner so that an application of the loudspeaker signals 12 at or to the plurality of loudspeakers 14 renders at least one audio object at an intended virtual position.

The apparatus 10 might be configured for a certain arrangement of loudspeakers 14, i.e., for certain positions in which the plurality of loudspeakers 14 are positioned or positioned and oriented. The apparatus may, however, alternatively be able to be configurable for different loudspeaker arrangements of loudspeakers 14. Likewise, the number of loudspeakers 14 may be two or more and the apparatus may be designed for a set number of loudspeakers 14 or may be configurable to deal with any number of loudspeakers 14.

The apparatus 10 comprises an interface 16 at which apparatus 10 receives an audio signal 18 which represents the at least one audio object. For the time being, let's assume that the audio input signal 18 is a mono audio signal which represents the audio object such as the sound of a helicopter or the like. Additional examples and further details are provided below. Alternatively, the audio input signal 18 may be a stereo audio signal or a multichannel audio signal. In any case, the audio signal 18 may represent the audio object in time domain, in frequency domain or in any other domain and it may represent the audio object in a compressed manner or without compression.

As depicted in FIG. 1, the apparatus 10 further comprises an object position input 20 for receiving the intended virtual position 21. That is, at the object position input 20, the apparatus 10 is notified about the intended virtual position 21 to which the audio object shall virtually be rendered by the application of the loudspeaker signals 12 at loudspeakers 14. That is, the apparatus 10 receives at input 20 the information of the intended virtual position 21, and this information may be provided relative to the arrangement/position of loudspeakers 14, relative to a sweet spot, relative to the position and/or head orientation of the listener and/or relative to real-world coordinates. This information could e.g. be based on Cartesian coordinate systems, or polar coordinate systems. It could e.g. be based on a room centric coordinate system or a listener centric coordinate system, either as a cartesian, or polar coordinate system.

Additionally, the apparatus 10 comprises a listener position input 30 for receiving the actual position of the listener. The listener position 31 may be defined by coordinates indicating a position of a listener within a reproduction space, e.g. a position of the body of the listener, of the head of the listener or of the ears of the listener, e.g., tracking data, i.e. information of the position of the listener over time. The listener position 31, for example, may be described in cartesian coordinates, in spherical coordinates or in cylindrical coordinates. Alternative to an absolute position of the listener, it is possible that the listener position 31 indicates a relative position of the listener, e.g. relative to a reference loudspeaker of the set of loudspeakers or relative to a sweet spot within the reproduction space or relative to any other predetermined position within the reproduction space.

For example, in case the intended virtual position 21 defines the position of an audio object relative to the listener position 31, the apparatus 10 might not necessarily need the listener position input 30 for receiving the listener position 31. This is due to the fact that the intended virtual position 21 already considers the listener position 31.

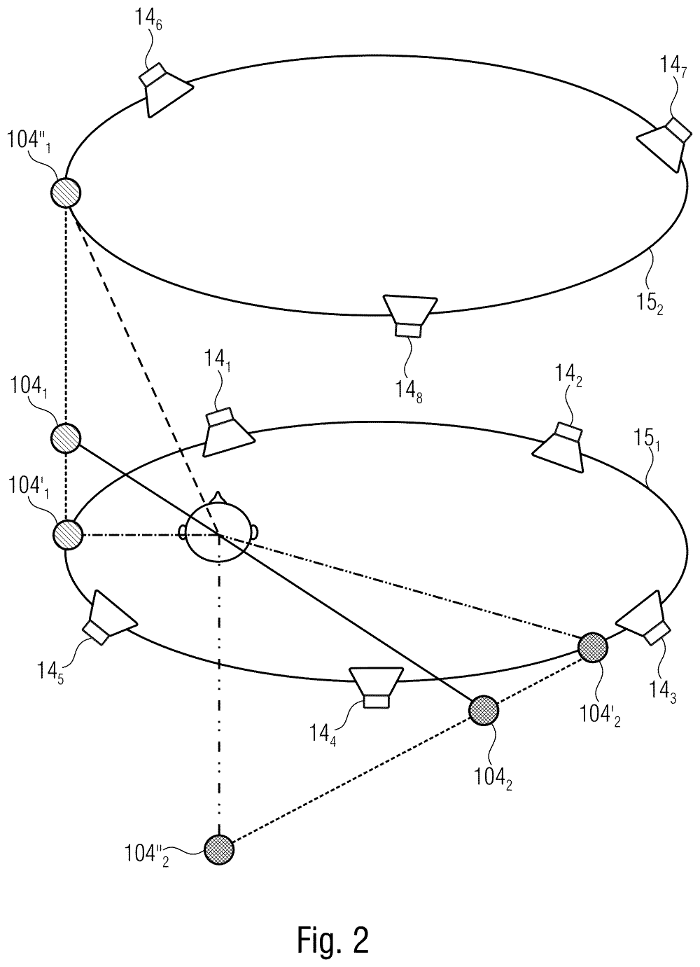

As depicted in FIG. 1, apparatus 10 may comprise a gain determiner 40 configured to determine, depending on the intended virtual position 21 received at input 20 and/or on the listener position 31 received at input 30, gains 41 for the plurality of loudspeakers 14. The gain determiner 40 may, according to an embodiment, compute amplitude gains, one for each loudspeaker signal, so that the intended virtual position 21 is panned between the plurality of loudspeakers 14 and/or so that a roll-off of sound energy is compensated. As outlined in more detail below, see FIG. 2, the gains 41 may comprise panning gains. A panning gain gₙ to be applied to the respective loudspeaker signal may comprise a horizontal component gₙ^{horizontal} and a vertical component gₙ^{vertical}, e.g., gₙ=gₙ^{horizontal}·gₙ^{vertical}. The index n represents a positive integer in the range 1≤n≤i, wherein i represents the number of loudspeakers 14. The gain determiner 40 may be configured to determine for each loudspeaker the respective gain 41, so that the application of the loudspeaker signals 12 at or to the plurality of loudspeakers 14 renders at least one audio object at an intended virtual position.

Additionally, or alternatively, the apparatus 10 may comprise a delay determiner/controller 50 to determine/control, depending on the intended virtual position 21 received at input 20 and/or on the listener position 31 received at input 30, delays 51 for the plurality of loudspeakers 14. The delay determiner 50 may be configured to determine for each loudspeaker the respective delay 51, so that the application of the loudspeaker signals 12 at or to the plurality of loudspeakers 14 renders at least one audio object at an intended virtual position and/or so that the loudspeaker signals reproduced by the loudspeakers 14 arrive at the listener at the same time.

The apparatus 10 may comprise an audio renderer 11 configured to render the audio signal 18 based on the gains 41 and/or the delays 51, so as to derive the loudspeaker signals 12 from the audio signal 18.

With regard to FIG. 2 a possible 3D panning performed by the panning gain determiner 40 is described in more detail.

The loudspeakers 14 can be arranged in one or more horizontal layers 15. As depicted in FIG. 2, a first set of loudspeakers 14₁ to 14₅ of the plurality of loudspeakers 14 may be arranged in a first horizontal layer 15₁ and a second set of loudspeakers 14₆ to 14₈ of the plurality of loudspeakers 14 may be arranged in a second horizontal layer 15₂. That is, the first set of loudspeakers 14₁ to 14₅, quasi, are arranged at similar heights and the second set of loudspeakers 14₆ to 14₈, quasi, are arranged at similar heights. The first set of loudspeakers 14₁ to 14₅ may be arranged at or near a first height and the second set of loudspeakers 14₆ to 14₈ may be arranged at or near a second height, e.g. above the first height. According to the embodiment shown in FIG. 2, the listener position 31 is exemplarily arranged within the first horizontal layer 15₁.

In the following, the case of rendering an object in 3D is explained for an example case where an object 104₁, e.g. a sound source, is panned in a direction (as seen from the listener 100) that lies between two physically present loudspeakers layers (which are at different height). The object 104₁ is amplitude panned in the first layer 15₁ by giving the object signal to loudspeakers in this layer with different first layer horizontal gains, e.g. by giving the object signal loudspeakers 14₁ to 14₅ such that it is amplitude panned to bottom layer, i.e. the first layer 15₁, see the panned first layer position 104′₁ in FIG. 2. At this horizontal panning, for example, for each loudspeaker of the first set of loudspeakers 14₁ to 14₅ a horizontal component gₙ^{horizontal} of the respective panning gain 41 is determined. Similarly, the object 104₁ is amplitude panned in the second layer 15₂ to the panned second layer position 104″₁ in FIG. 2. At this horizontal panning, for example, for each loudspeaker of the second set of loudspeakers 14₆ to 14₈ a horizontal component gₙ^{horizontal} of the respective panning gain 41 is determined. As can be seen, positions 104′₁ and 104″₁ may be selected so that they vertically overlay each other and/or so that the vertical projection of intended position 104₁ and the positions 104′₁ and 104″₁ coincide as well. FIG. 2 illustrates rendering the final object position 104₁ by applying amplitude panning between the layers 15, i.e. illustrates the vertical panning. Considering the virtual objects at positions 104′₁ and 104″₁ as virtual loudspeakers, amplitude panning by the gain determiner 40 is applied to render the virtual object at intended position 104₁, between the two layers 151 and 152. At this vertical panning, for example, for each loudspeaker of the first set of loudspeakers 14₁ to 14₅ and of the second set of loudspeakers 14₆ to 14₈ a vertical component gₙ^{vertical} of the respective panning gain 41 is determined. The result of this amplitude panning between the layers 15₁ and 15₂ are two gain factors, i.e. a horizontal component gₙ^{horizontal} and a vertical component gₙ^{vertical}, for each loudspeaker with which the respective loudspeaker signal is weighted, e.g., so that a sound source of the audio signal is panned to a desired audio signal's sound source position. This weighting for the horizontal panning between (real) loudspeaker layers 15 can additionally be frequency dependent to compensate for the effect that in vertical panning different frequency ranges may be perceived at different elevation.

In the following, the case of rendering an object in 3D is explained for an example case where an object 104₂ is panned above or below an outmost layer. An object may have a direction or position 104₂ which is not within the range of directions between two layers 15₁ and 15₂ as discussed with regard to the object position 104₁. An object's intended position 104₂, for example, is above or below a (physically present) layer 15, here below any available layer and, in particular, below the lower one, i.e. the first layer 15₁. As an example, the object has a direction/position 104₂ below the bottom loudspeaker layer, i.e. the first layer 15₁, of the loudspeaker setup which has been used as an example set-up in FIG. 2. In this case, horizontal amplitude panning is applied by the panning gain determiner 40 to the bottom layer to render the object 104₂ in that layer 15₁, see the resulting position 104′₂. The resulting position 104′₂ may represent a virtual source position corresponding to a projection of a desired audio signal's sound source position, see 104₂, onto the nearest loudspeaker layer, see 15₁. More generally speaking, a 2D amplitude panning is applied between the loudspeakers 14₁ to 14₅ attributed to a loudspeaker layer, i.e. the first layer 15₁, nearest to the object 104₂. At this horizontal panning, for example, for each loudspeaker of the first set of loudspeakers 14₁ to 14₅ a horizontal component gₙ^{horizontal} of the respective panning gain 41 is determined. Then a further amplitude panning is applied between the loudspeakers 14₁ to 14₅ attributed to the nearest loudspeaker layer, i.e. the first layer 15₁, along with a spectral shaping of the audio signal so as to result into a sound rendition by the loudspeakers 14₁ to 14₅ of the nearest loudspeaker layer, i.e. the first layer 15₁, which mimics sound from a further virtual source position 104″₂ offset from the nearest loudspeaker layer, i.e. the first layer 15₁, towards the desired audio signal's sound source position, see 104₂. Since there is no real loudspeaker at the vertical top or bottom direction, the vertical signal at 104″₂ may be equalized to mimic coloration of top or bottom sound respectively. The vertical signal is then given to the loudspeakers designated for top/bottom direction. In order to render the final object position 104₂ the panning gain determiner 40 may be configured to apply an even further amplitude panning between the virtual sound source position 104′₂ and the further virtual sound source position 104″₂, so as to determine second panning gains for a panning between the virtual sound source position 104′₂ and the further virtual sound source position 104″₂ so as to result into a rendering of the audio signal by the nearest loudspeaker layer's loudspeakers 14₁ to 14₅ from the desired audio signal's sound source position 104₂. The spectral shaping of the audio signal may be performed using a first equalizing function which mimics a timbre of bottom sound if the desired audio signal's sound source position 104₂ is positioned below to the one or more loudspeaker layers, i.e. below the first layer 15₁, and/or perform the spectral shaping of the audio signal using a second equalizing function which mimics a timbre of top sound if the desired audio signal's sound source position is positioned above the one or more loudspeaker layers, i.e. above the second layer 15₂.

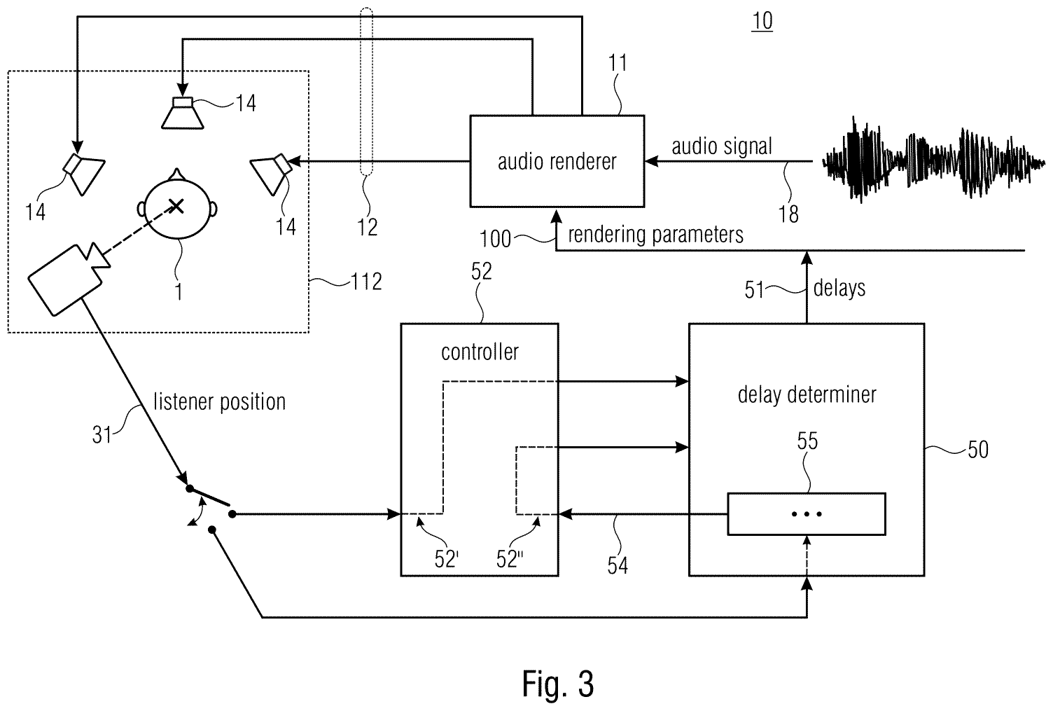

FIG. 3 shows an embodiment of an audio processor 10 for performing audio rendering, see the audio renderer 11, by generating rendering parameters 100, which determine a derivation of loudspeaker signals 12 to be reproduced by a set of loudspeakers 14 from an audio signal 18. The focus of the embodiment shown in FIG. 3 lies on the delay determiner 50. Optionally, same may be combined with a gain determiner 40, as described with regard to FIG. 1.

The audio processor 10 is configured to perform a delay processing, see the delay determiner 50, so as to determine, based on a listener position 31, delays 51 for generating the loudspeaker signals 12 for the loudspeakers 14 from the audio signal 18. The audio processor 10 is configured to control, see the controller 52, the delay processing by modifying 52′ a version of the listener position 31, based on which the delay processing is commenced, or by modifying 52″ any intermediate value 54 determined by the delay processing based on the listener position 31 so as to reduce artifacts in the audio rendition due to changes in the delays 51. The modification 52′ or 52″ may be performed by smoothing, clipping, and/or scaling the respective input. The scaling may be performed using a monotonically increasing function having monotonically decreasing slope.

The version of the listener position 31 may correspond to an absolute listener position within a reproduction space 112, a listener's velocity, the listener's velocity towards one or more of the set of loudspeakers 14, a listener's acceleration, the listener's acceleration towards one or more of the set of loudspeakers 14, a distance of the listener 1 to one or more of the set of loudspeakers 14, a temporal rate of change of the distance of the listener 1 to one or more of the set of loudspeakers 14 and/or a change rate of the temporal rate of change of the distance of the listener 1 to one or more of the set of loudspeakers 14.

The intermediate value 54 may correspond to a delay for one or more of the set of loudspeakers 14, a temporal rate of change of the delay for one or more of the set of loudspeakers 14, and/or a change rate of the temporal rate of change of the delay for one or more of the set of loudspeakers 14.

It is an idea of the underlying embodiments of the present invention that limiting the variability (noisiness) of the listener position 31, e.g. input listener tracking data, or of derived values, e.g., the intermediate value 54, may be used to avoid artifacts in the adaptive rendering, specifically in the effect of the variable delay lines (VDLs). While avoiding artifacts related to delay adjustment, it is still possible to react fast enough to listener motion. For example, motion speed and/or acceleration may be used to control the changes in the VDL operation, e.g., by the controller 52.

Thus, the above thoughts result, according to an embodiment, into an audio processor, for example, comprising.
Means, see the controller 52, for controlling the delay processing of the loudspeaker audio signal 12 (aspect: “what to control/smooth?”)
Control criteria steering the above delay control/smoothing (aspect: “how to control/depending on what criteria?”). For example, the controller 52 may obtain control parameters or control information, controlling the modification 52′ and/or 52″.

According to an embodiment, the audio processor 10 is configured to derive from control information one or more of information on an intensity of the smoothing, information on a clipping threshold for the clipping, and information on a parametrization of the monotonically increasing function having monotonically decreasing slope.

Means for controlling the delay processing: Inside the user-adaptive renderer, see the audio processor 10, the following calculation is, according to an embodiment, executed for each loudspeaker 14: From the tracked user positions 31 (which might be jittery) the distance between the user, i.e. the listener 1, and the respective loudspeaker 14 is computed, e.g., by a delay processing unit 55 of the delay determiner 50. The distance may then be converted into a respective delay, e.g. the intermediate value 54, that normally needs to be applied to the loudspeaker feed signal (specified in either samples at the system's sampling rate or in seconds/milliseconds). This target delay may normally then be used to control the Variable Delay Lines (VDLs) of the system. However, a too fast or erroneous change of delays may result in artefacts in the audio rendition. Therefore, it is proposed to, for example, input such delays as intermediate values 54 into the controller 52 or directly input a version of the listener position 31 into the controller 52, since a too fast change of the listener position 31 or an erroneous listener position 31 results in the too fast or erroneous change of the delays. Consequently, there are several possibilities for limiting the possible impact of too fast and erroneous changes in delay:
The delay that is calculated in each processing frame can be smoothed/controlled, e.g., by the modification 52″ (most advantageous variant)
   In an advantageous variant of this, the change (difference) in sample delay from frame to frame is limited/controlled.
Furthermore, e.g., additionally, or alternatively, the user-loudspeaker distance calculated in each processing frame can be smoothed/controlled, e.g., by the modification 52′
   In an advantageous variant of this, the change (difference) in user-loudspeaker distance from frame to frame is limited/controlled.
Furthermore, e.g., additionally, or alternatively, the tracked user positions used in each processing frame can be smoothed/controlled, e.g., by the modification 52′ (this is the least advantageous variant).
   Specifically, the change (difference) in user position from frame to frame may be limited/controlled

Control criteria: In order to control the delay processing (as described above), several intelligent criteria can be employed that make sure that the regular operation of the processor is not disturbed (i.e. the delay adjustment works in an optimal way to provide the listener 1 with the—ideally—same sound quality as in the sweet spot and react fast enough when the listener 1 moves within the room, i.e. the reproduction space 112, and with respect to the loudspeaker setup. Yet, at the same time, there should be no artifacts generated due to the time-varying delay even for very critical sound material like tonal sounds (sine tones with high frequency, pitch pipe, glockenspiel).

As intelligent control criteria for the delay processing, one or more parameters can be used including
Estimated listener velocity (expressed in m/s or other equivalent units). This can be measured either as
   Velocity in 3D space, or
   Velocity in the direction towards the loudspeaker (possible, but less advantageous)
Estimated listener acceleration (expressed in m/s² or other equivalent units)
   Acceleration in 3D space, or
   Acceleration in the direction towards the loudspeaker (possible, but less advantageous).
Alternatively, as a simple but less effective approach, the control of the VDL action can be performed by directly applying temporal smoothing on the variables in the calculation chain themselves (see above), i.e.:
   VDL delay
   user-loudspeaker distance
   tracked user position

Thus, an audio signal processor 10 may comprise
Means, e.g. the controller 52, for controlling the delay processing of the loudspeaker audio signal 18 (aspect: “what to control?”)
   See above (VDL delay, user-loudspeaker distance, tracked user position)
Control criteria steering the above delay control (aspect: “how to control/depending on what criteria?”)
   See above (velocity, acceleration)
   Alternative (see above): Direct smoothing of
      VDL delay
      user-loudspeaker distance
      tracked user position

An embodiment according to this invention is related to an audio processor 10 configured for generating, for each of a set of one or more loudspeakers 14, a set of one or more parameters, i.e. the rendering parameters 100, (this can, for example, be parameters, which can influence the delay, level or frequency response of one or more audio signals 18), which determine a derivation of a loudspeaker signal 12 to be reproduced by the respective loudspeaker 14 from an audio signal 18, based on a listener position 31 (the listener position 31 can, for example, be the position of the whole body of the listener 1 in the same room, i.e. the reproduction space 112, as the set of one or more loudspeakers 14, or, for example, only the head position of the listener 1 or also, for example, the position of the ears of the listener 1. The listener position 31 can, for example, be a position in reference to the set of one or more loudspeakers 14, for example, a distance of the listener's head to the set of one or more loudspeakers 14) and loudspeaker position of the set of one or more loudspeakers 14.

Loudspeaker signal delay adjustment may be performed by a variable (fractional) delay line (VDL). While the steady-state adjustment of a VDL is not critical, its dynamic behavior, while interactively adjusting the VDL delay dependent on user movement via the delay control signal, should be carefully restricted to avoid perceptual impairments. Possible perceptual impairments originate from the fact that a dynamically adjusted delay line implements a phase modulation on the audio signal 18 that is processed in that delay line steered by the control signal.

Unrestricted phase modulations may cause auditory roughness and/or a perceivable pitch shift of tonal signals. Auditory roughness originates from fast modulations within the control signal, caused by e.g. position tracking time jitter or the sample-and-hold behaviour of a too slow or unstable position data acquisition. Perceivable pitch shift or instantaneous jumps in pitch shift may be caused by a too fast user movement or instantaneous change in user movement.

Therefore, one or more of the following counter-measures are perceptually beneficial:
Restriction of allowable delay change, e.g., by the modification 52″, limits audible pitch offset through limitation of instantaneous frequency modification.
Restriction of allowable change of delay change, e.g., by the modification 52″, avoids audible pitch jumps through limitation of instantaneous frequency jumps
Adjusting absolute delays as opposed to relative (to a dynamically chosen reference channel with minimum delay) delays, e.g., by the modification 52″, avoid unnecessary instantaneous frequency jumps, especially due to listener movements near the sweet spot where otherwise the reference channel abruptly changes
Adjusting absolute delays as opposed to relative (to a dynamically chosen reference channel with minimum delay) delays, e.g., by the modification 52″, minimized bias in the perceived pitch offset of the sum of all channels since pitch offsets can be up in one channel and down in another channel and thus stay centered around the true pitch where otherwise the reference channel would remain unmodified and only the other channels are modified in one direction

Note that in addition to the smoothing, clipping, and/or scaling with a monotonically increasing function having monotonically decreasing slope, an interpolation may be applied, e.g., by the controller 52 at the modification 52′ or 52″, so as to interpolate from frame to frame. In other words, the smoothing, clipping, and/or scaling with a monotonically increasing function having monotonically decreasing slope may be, just as it is true for other tasks such as gain adaptation and panning, done in units of frames, and interpolation between consecutive smoothened/clipped/scaled values, i.e. values of consecutive frames, may be used to vary the delay in units finer than the frames, to thereby lead from the previous frame's value to the value of the current frame.

Now, an embodiment of the present invention is described, here for adaptive loudspeaker rendering.

General notes shall be made at the beginning. As an alternative to rendering and binauralizing MPEG-I scenes to headphones, the playback over loudspeakers is specified. In this operation mode, the MPEG-I Spatializer (HRTF based renderer) is replaced with a dedicated loudspeaker-based renderer which is explained below.

For a high quality listening experience, loudspeaker setups assume the listener 1 to be situated in a dedicated fixed location, the so-called sweep spot. Typically, within a 6 DOF playback situation, the listener 1 is moving. Therefore, the 3D spatial rendering has to be instantly and continuously adapted to the changing listener position 31. This may be achieved in two hierarchically nested technology levels:
1. Gains 41 and delays 51, for example, are applied to the loudspeaker signals 12 such that at the loudspeaker signals 12 reach the listener position 31 at a similar gain and delay, i.e. so that same lies in the sweet spot. Optionally a high shelving compensation filter is applied to each loudspeaker signal 12 related to the current listener position 31 and the loudspeakers' orientation with respect to the listener 1. This way, as a listener 1 moves to positions off-axis for a loudspeaker 14 or further away from it, high frequency loss due to the loudspeaker's radiation high-frequency pattern is compensated.
2. Due to the 6 DoF movement, the angles between loudspeakers 14, objects and the listener 1 change as a function of listener position 31. Therefore, a 3D amplitude panning algorithm, see FIG. 2, for example, is updated in real-time with the relative positions and angles of the varying listener position 31 and the fixed loudspeaker configuration as set in the LSDF. All coordinates (listener position 31, source positions) may be transformed in the listening room coordinate system, i.e. into the coordinate system of the reproduction space 112.

### Physical Compensation Level (Level 1)

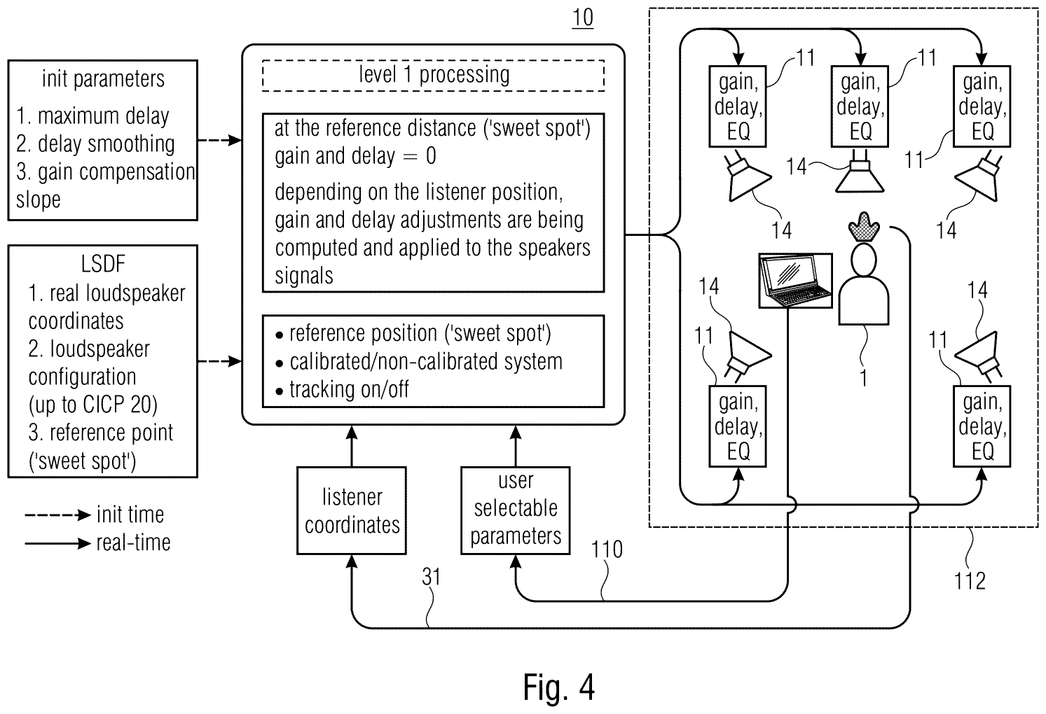

FIG. 4 shows an overview of an embodiment of a Level 1 system 10 with its main components and parameters. The audio processor 10 described with regard to FIGS. 1 to 3 may comprise features and or functionalities as described with regard to the embodiment of FIG. 4.

Level 1: real-time updated compensation of loudspeaker (frequency-dependent) gain & delay, see the audio renderer 11, enables ‘enhanced rendering of content’. By exploiting the tracked user position information, e.g. a version of the listener position 31, the listener 1, i.e. user, can move within a large “sweet area” (rather than a sweet spot) and experience a stable sound stage in this large area when, for example, listening to legacy content (e.g. stereo, 5.1, 7.1+4H). For immersive formats (i.e., not for stereo), the sound seems to detach from the loudspeakers 14 rather than collapse into the nearest speakers 14 when walking away from the sweet spot, i.e. a quality somewhat close to what is known from wavefield synthesis, but for a single-user experience. For stereo reproduction, the technology offers left-right sound stage stability for a wide range of user positions 31 (i.e. the range between the left and right loudspeakers at arbitrary distance).

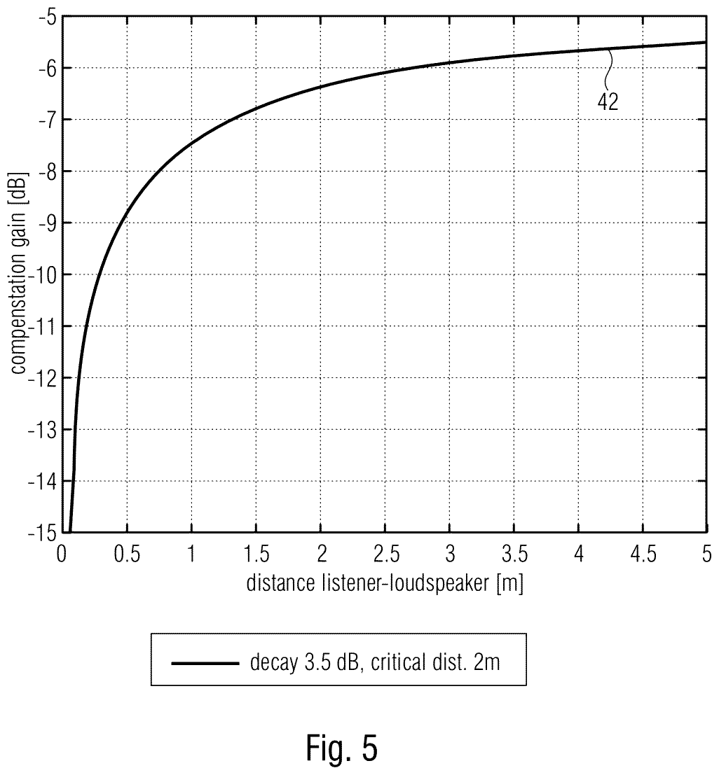

The gain compensation in Level 1, for example, is based on an amplitude decay law. In free field, the amplitude is proportional to 1/r, where r is the distance from the listener 1 to a loudspeaker 14 (1/r corresponds to 6 dB decay per distance doubling). In a room 112, due to the presence of acoustic reflections and reverberation, sound is decaying more slowly as the distance to a loudspeaker 14 increases. Therefore nearfield decay, farfield decay, and/or critical distance parameters, e.g. comprised by reverberation effect information 110, may be used to specify decay rate as a function of distance to a loudspeaker 14. Additionally there might be a nearfield-farfield transition parameter beta, e.g. comprised by reverberation effect information 110. The larger beta is, the faster is the transition between nearfield and farfield decay. FIG. 5 shows an example of a gain compensation as a function of distance, i.e. a roll-off gain compensation function 42 usable for determining a compensation gain applicable by the audio renderer 11. In the reverberant field, the gain change is smaller than in the free-field.

The delay compensation in Level 1, for example, computes the propagation delay from each loudspeaker 14 to the listener position 31 and then applies a delay to each loudspeaker 14 to compensate for the propagation delay differences between loudspeakers 14. Delays may be normalized (offset added or subtracted) such that the smallest delay applied to a loudspeaker signal 12 is zero.

### Object Rendering Level (Level 2)

Level 2: user-tracked object panning enables rendering of point sources (objects, channels) within the 6 DoF play space and requires Level 1 as a prerequisite. Thus, it addresses the use case of ‘6 DoF VR/AR rendering’. The following features and/or functionalities can additionally be comprised by the Level 1 system 10.

A 3D amplitude panning algorithm may be used which works in loudspeaker layers, e.g. horizontal and height layers, e.g., as described with regard to FIG. 2. Each layer may apply a 2D panning algorithm for the projection of the object onto the layer. The final 3D object is rendered by applying amplitude panning between the two virtual objects from the 2D panning in the two layers.

When an object is located above the highest layer, then 2D panning is applied in that layer. The final 3D object is rendered by applying amplitude panning between the virtual object from the 2D panning and an (non-existent) object in an upper vertical direction. The signal of the vertical object may be equalized to mimic timbre of top sound and equally distributed to the loudspeakers of the highest layer.

When an object is located below the lowest layer, then 2D panning is applied in that layer. The final 3D object is rendered by applying amplitude panning between the virtual object from the 2D panning and an (non-existent) object in an below vertical direction. The signal of the vertical object may be equalized to mimic timbre of bottom sound and equally distributed to the loudspeakers of the lowest layer.

The vertical panning as described, is equally applicable to loudspeaker setups with one layer such as 5.1 and with multiple layers such as 7.4.6.

Levels 1 and 2 applied to object rendering faithfully renders MPEG-I scenes like over headphones. This is of great benefit, compared to loudspeaker rendering MPEG-I content without applying adaptive tracking (1 and 2).

### Physical Compensation Level (Level 1)

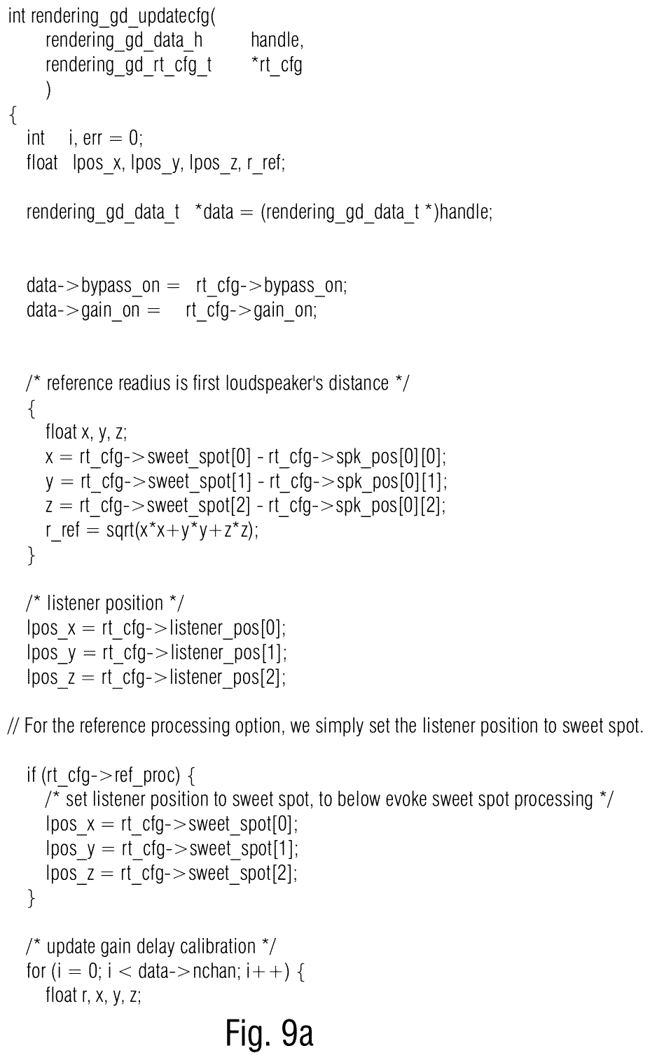

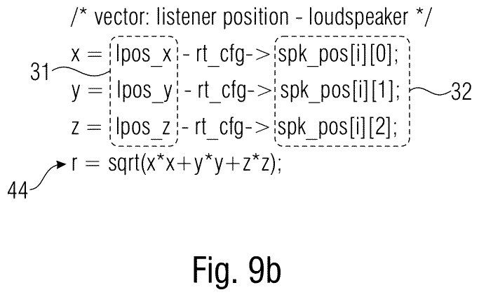

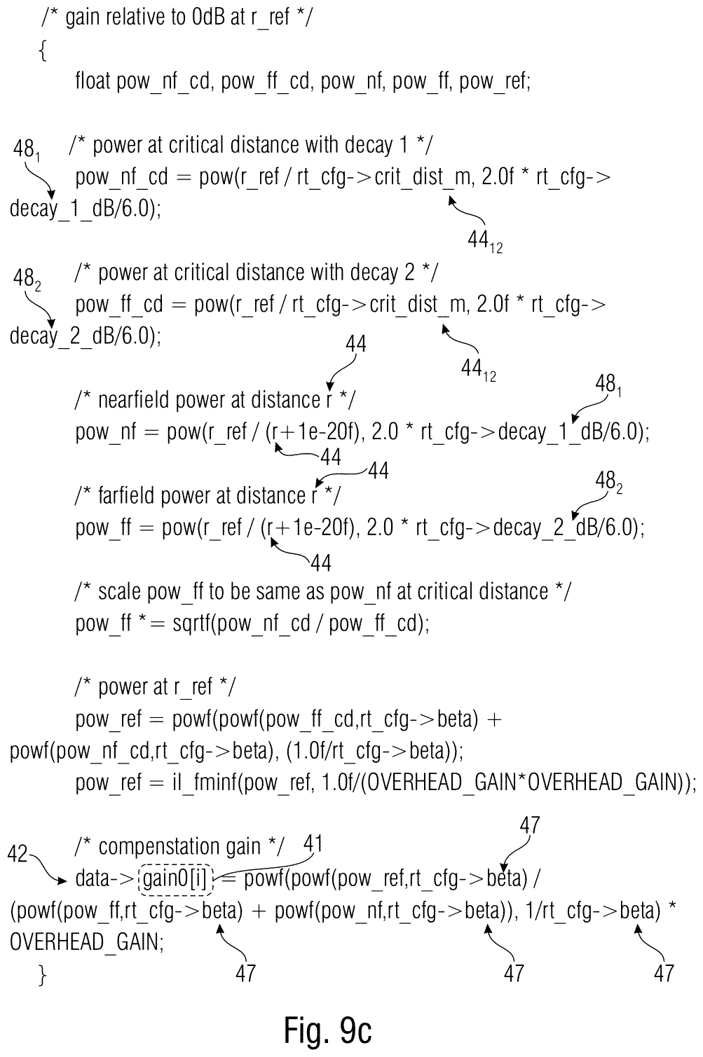

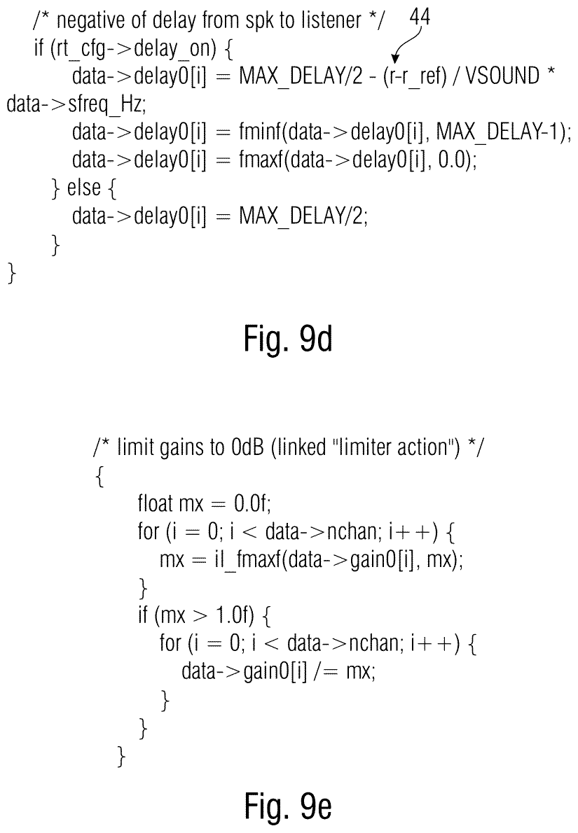

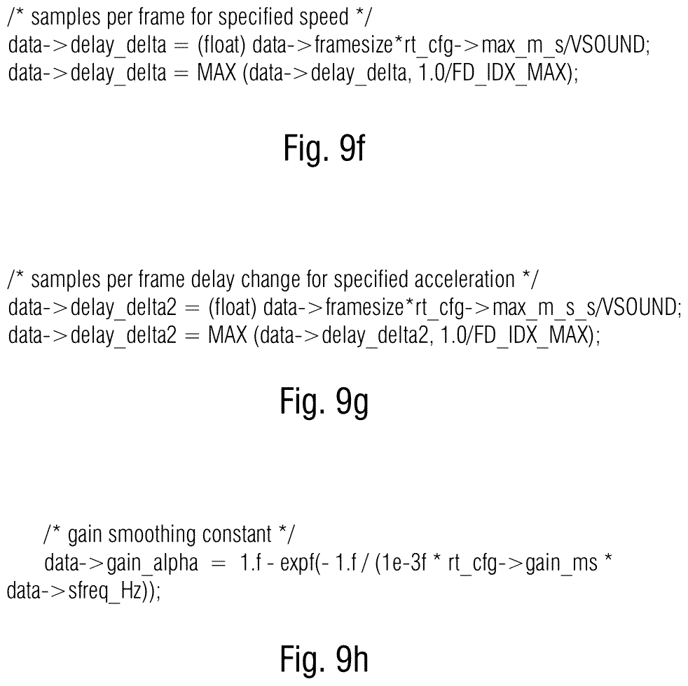

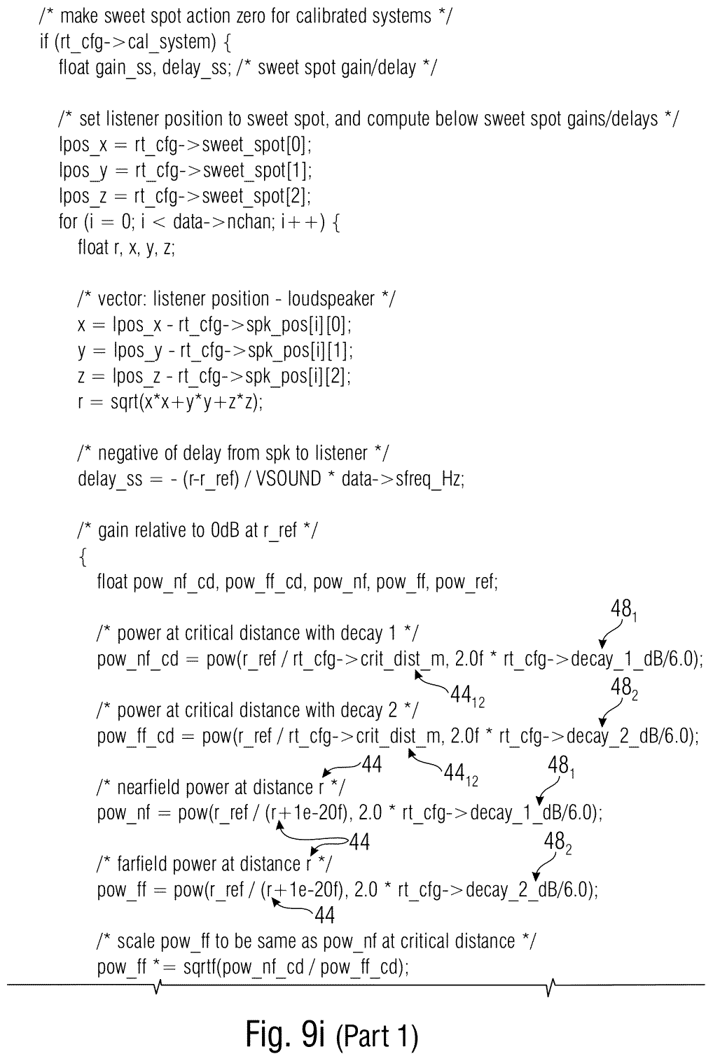

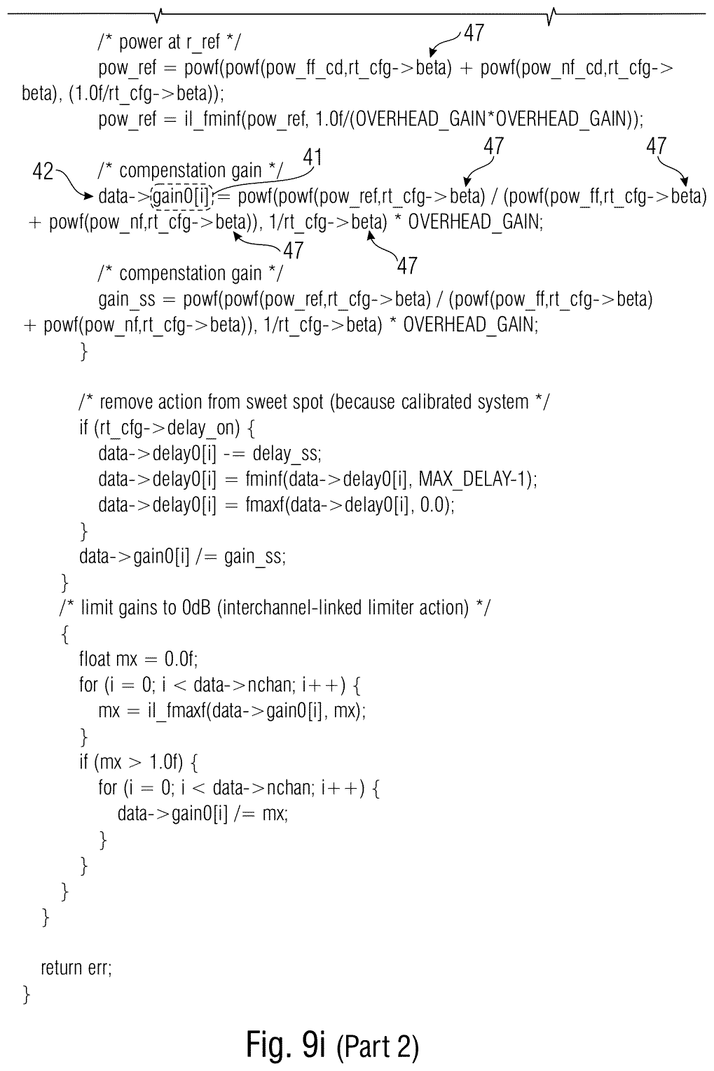

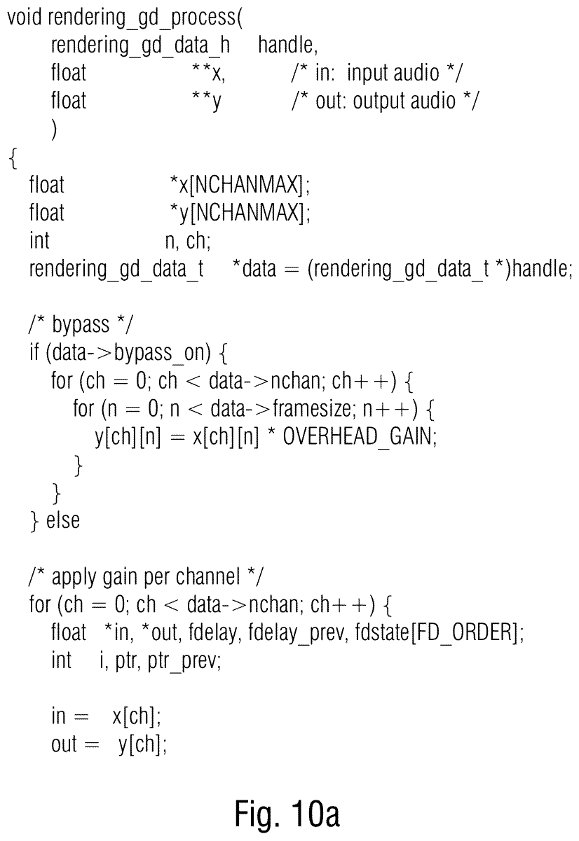

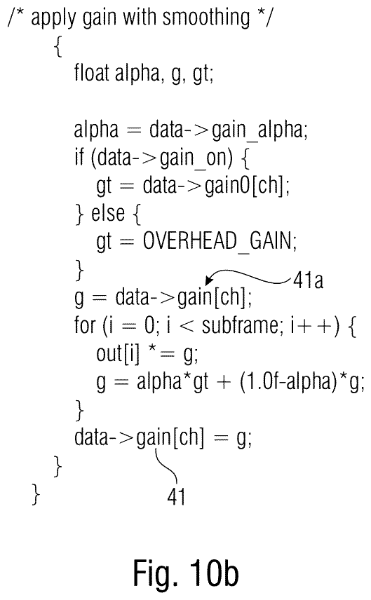

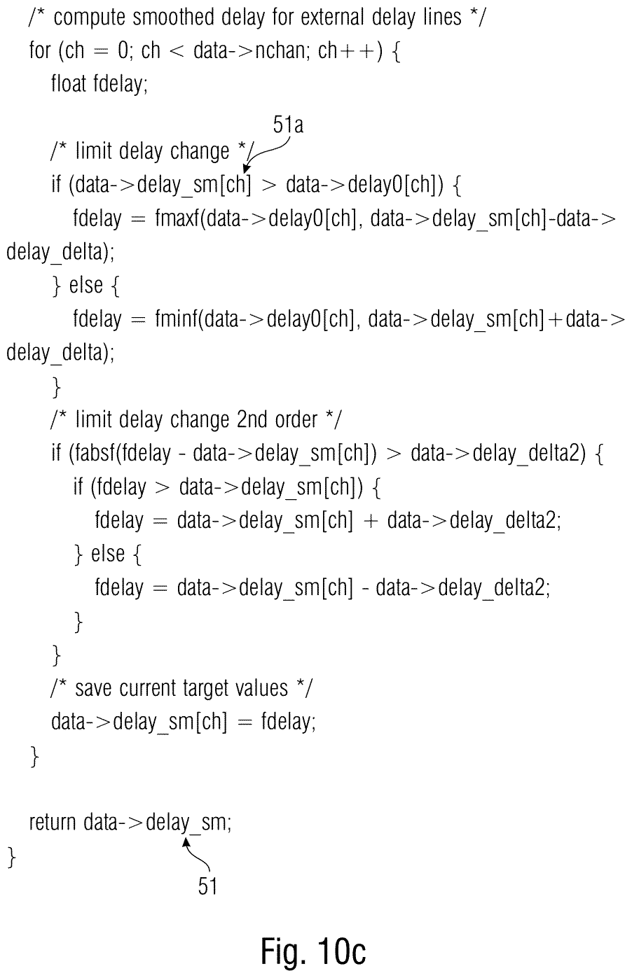

In the following an embodiment of gain and delay adjustment based on a listener position is described using code snippets, see FIGS. 9c to 9i and FIG. 10b and FIG. 10c. Features and/or functionalities described in the following with regard to the gain and/or delay adjustment may be comprised by the audio processor 10 of FIG. 1 or by the Level 1 system 10 of FIG. 4. The audio processor 10 of FIG. 3 may additionally comprise features and/or functionalities described in the following with regard to the delay adjustment. Optionally, the audio processor 10 of FIG. 3 may comprise features and/or functionalities described in the following with regard to the gain and/or delay adjustment. Optionally, the audio processor 10 of FIG. 1, the audio processor 10 of FIG. 3 and the audio processor 10 of FIG. 3 may comprise further features and/or functionalities as described below.

### Data Elements and Variables

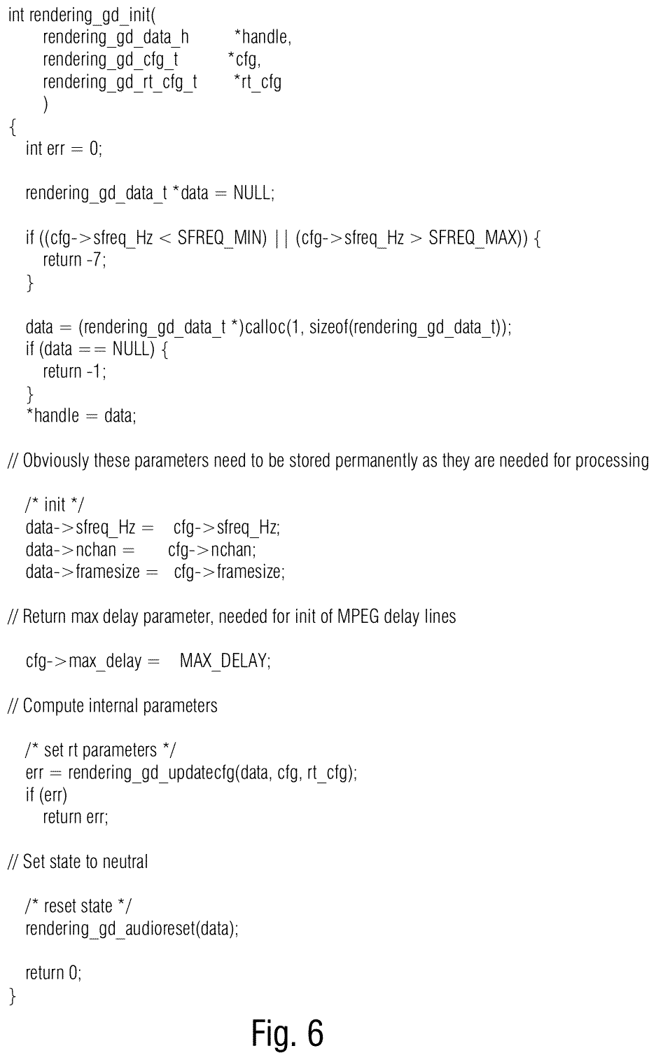

Definitions and/or explanations of data elements and variables used in the following, see FIGS. 6 to 10c, are provided:
SFREQ_MIN minimum sample rate [Hz]=44100
SFREQ_MAX maximum sample rate [Hz]=48000
VSOUND speed of sound in air [m/s]=340.0
MAX_DELAY maximum delay [samples]=960
OVERHEAD_GAIN overhead [lin]=0.25
framesize number of samples per frame, default: 256
sfreq_Hz sampling frequency of input audio, default: 48000
nchan number of channels (loudspeakers)
max_delay maximum delay [samples], default: MAX_DELAY
bypass_on 0: normal operation, 1: bypass, default: 0
ref_proc 0: normal operation, 1: processing like for sweet spot, default: 0
cal_system 0: normal operation, 1: calibrated system, default: 0
gain_on 0: gain off, 1: on, default: 1
delay_on 0: delay off, 1: on, default: 1
decay_1_dB nearfield sound decay per distance doubling [dB], default: 8
decay_2_dB farfield sound decay per distance doubling [dB], default: 0
beta 1: default nearfield-farfield transition, >1 faster transition
crit_dist_m critical distance [m], default: 4
max_m_s maximum movement velocity [v in m/s], default: 1
max_m_s_s maximum movement acceleration [a in m/s], default: 1
gain_ms gain smoothing time constant [ms], default: 40
sweet_spot sweet spot position [m,m,m]
spk_pos loudspeaker coordinates [m,m,m]
listener_pos listener coordinates [m,m,m]

All coordinates, for example, are relative to the listening room as defined in the LSDF file.

These parameters may be stored in the following structures:

Public data structures

| typedef struct rendering_gd_cfg { | |
|---|---|
| int | framesize; |
| float | sfreq_Hz; |
| int | nchan; |
| float | max_delay; |
| } rendering_gd_cfg_t; | |
| typedef struct rendering_gd_rt_cfg { | |
| int | bypass_on; |
| int | ref_proc; |
| int | cal_system; |
| int | gain_on; |
| int | delay_on; |
| float | decay_1_dB; |
| float | decay_2_dB; |
| float | crit_dist_m; |
| float | beta; |
| float | max_m_s; |
| float | max_m_s_s; |
| float | gain_ms; |
| float | sweet_spot [3]; |
| float | spk_pos [NCHANMAX] [3]; |
| float | listener_pos [3]; |

} rendering_gd_rt_cfg_t;

Internal parameters that are calculated from the above listed parameters and states, for example, are stored in the following structure:

Internal data structure

| typedef struct { | |
|---|---|
| /* static parameters */ | |
| float | sfreq_Hz; |
| int | nchan; |
| int | framesize; |
| /* real-time parameters */ | |
| int | bypass_on; |
| int | gain_on; |
| float | delta_gi; |
| float | delta_gd; |
| float | gain_alpha; |
| float | delay_delta; |
| float | delay_delta2; |
| /* state */ | |
| float | delay0 [NCHANMAX]; |
| float | delay [NCHANMAX]; |
| float | gain0 [NCHANMAX]; |
| float | gain [NCHANMAX]; |

} rendering_gd_data_t;

### Stage Description

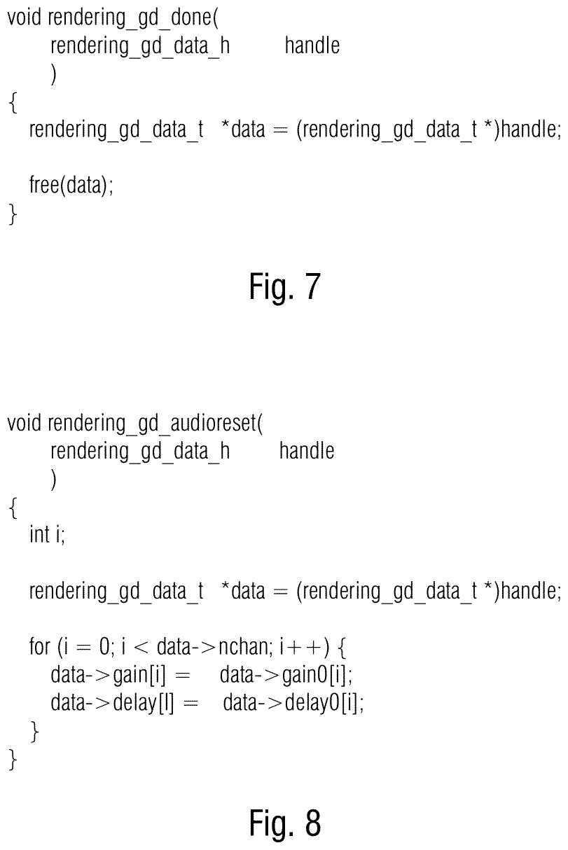

The embodiment of gain and delay adjustment based on a listener position is described in the following using code snippets associated with different stages. The embodiment may comprise an initialization stage (see FIG. 6), a release stage (see FIG. 7), a reset stage (see FIG. 8), a real-time parameters update stage (see FIGS. 9a to 9i), and an audio processing stage (see FIGS. 10a to 10c). The audio processor 10 of FIG. 1, the Level 1 system 10 of FIG. 4 and the audio processor 10 of FIG. 3 may comprise features and/or functionalities described with regard to one or more of the stages or individual features and/or functionalities of one or more stages.

### Initialize

FIG. 6 shows exemplarily a code snippet of the initialization stage.

The loudspeaker setup may be loaded from a LSDF file.

A structure of type rendering_gd_cfg_t is initialized with default values and the nchan field is set to the number of loudspeakers in the loudspeaker setup.

A structure of type rendering gd_rt_cfg t is initialized with default values. The loudspeaker positions from the LSDF file are stored in the field spk_pos. If the ReferencePoint element was given in the LSDF file, its coordinates are stored in the field sweet_spot. The field cal_system is set to the value of the attribute calibrated if present.

The aforementioned structures are passed to the rendering_gd_init function.

### Release FIG. 7 shows exemplarily a code snippet of the release stage.

### Reset

FIG. 8 shows exemplarily a code snippet of the reset stage. FIG. 8 shows that all internal buffers are flushed.

### Update Real-Time Parameters

In the update thread, the virtual listener position is transformed into the listening room coordinate system. This is only relevant for VR scenes, in AR scenes the two coordinate systems coincide.

All further processing happens in the audio thread.

The structure of type rendering_gd_rt_cfg_t is updated by setting the listener_pos field to the listener position (in the listening room coordinate system), see FIG. 9a. The structure is then passed to the rendering_gd_updatecfg function, see FIG. 9a.

For each loudspeaker the compensation gain and delay is computed. The reference distance r_ref (computed in FIG. 9a) is the distance at which gain and delay compensation are zero (dB, samples). Based on the loudspeaker's distance to listener r and reference distance r_ref, gain and delay compensation are computed. The computation of the listener-to-loudspeaker distance 44 based on the listener position 31 and the respective loudspeaker position 32 is shown in FIG. 9b. The listener-to-loudspeaker distance 44 may represent a version of the listener position 31.

In freefield sound decays by 6 dB per distance doubling. In a room, decay can be approximated by using less decay, e.g. 4 dB per distance doubling. Alternatively, one can consider critical distance (hall radius). When one is near a loudspeaker, decay is decay_dB per distance doubling. Beyond the critical distance crit_dist_m sound is only decaying slowly. It is proposed to use a roll-off gain compensation function 42 (see FIG. 5 and FIG. 9c and FIG. 9i) for determining gain compensation that compensates gain changes due to the described sound decay.

The gain compensation may be based on an amplitude decay law. In free field, the amplitude is proportional to 1/r, where r is the distance from the listener to a loudspeaker (1/r corresponds to 6 dB decay per distance doubling). In a room, due to the presence of acoustic reflections and reverberation, sound is decaying more slowly as the distance to a loudspeaker increases. Therefore nearfield decay, farfield decay, and critical distance parameters may be used to specify decay rate as a function of distance to a loudspeaker. Additionally there is a nearfield-farfield transition parameter beta 47. The larger beta is, the faster is the transition between nearfield and farfield decay. The roll-off gain compensation function 42 may depend on the nearfield-farfield transition parameter beta 47. The nearfield-farfield transition parameter beta 47 may define how fast the roll-off gain compensation function 42 transition between nearfield and farfield, i.e. how fast the roll-off gain compensation function 42 transitions from a steep increase of compensation gain per listener-to-loudspeaker distance 44 to a shallow/slight increase of compensation gain per listener-to-loudspeaker distance 44.

Note that the circumstance that the compensated roll-off gets monotonically shallower with increasing listener-to-loudspeaker distance 44, may be embodied by the slope of the compensated roll-off energy, when measured in logarithmic domain, monotonically decreasing with increasing listener-to-loudspeaker distance 44.

The roll-off gain compensation function 42 maps the listener-to-loudspeaker distance 44 associated with a loudspeaker onto a listener-to-loudspeaker-distance compensation gain 41 for the loudspeaker associated with the listener-to-loudspeaker distance 44. The roll-off gain compensation function 42 may be configured to compensate a roll-off that gets monotonically shallower with increasing listener-to-loudspeaker distance 44. As noted above, in reproduction spaces, in which reverberation is effective, sound energy may decay in the nearfield differently than in the farfield. Therefore, it is proposed to use a first decay parameter 48₁, see decay_1_dB, for the nearfield, i.e. a first distance zone, and a second decay parameter 48₂, see decay_2_dB, for the farfield, i.e. a second distance zone, wherein first distance zone is associated with smaller listener-to-loudspeaker distances 44 than the second distance zone. As can be seen in FIG. 9c and FIG. 9i the roll-off gain compensation function 42 considers the different decays 48₁ and 48₂ for the nearfield and the farfield at the determination of the compensation gain 47 for a certain listener-to-loudspeaker distance 44. For example, the roll-off gain compensation function 42 may consider how much sound energy decayed at the listener-to-loudspeaker distance 44 according to the first decay parameter 48₁, see pow_nf, and according to the second decay parameter 48₂, see pow_ff.

A critical distance 44₁₂ separates the nearfield and the farfield. The sound energy decaying according to the second decay parameter 48₂, see pow_ff, may be scaled, so that a decay of sound energy according to the first and second decay parameter 48₁ and 48₂ is equal at the critical distance 44₁₂. The a first decay parameter 48₁ may indicate a faster decay of sound energy as the second decay parameter 48₂. Therefore, for the roll-off gain compensation function 42 the compensated roll-off gets monotonically shallower with increasing listener-to-loudspeaker distance 44.

Further, the roll-off gain compensation function 42 may consider how much sound energy decayed at the sweet spot, see pow_ref at the sweet spot r_ref. Thus, the gain adjustment is performed, so that the listener position becomes a sweet spot relative to the set of loudspeakers in an acoustic or perceptual sense. The sound energy decayed at the sweet spot may be determined considering both the first and second decay parameter 48₁ and 48₂.

Depending on distance 44 of loudspeaker to listener position, sound transmission time is varying. These variations may be compensated by applying delays. An offset MAX_DELAY/2, for example, is added to the compensation delays, such that they are positive, see FIG. 9d. Further, the listener-to-loudspeaker distance may be considered at the delay determination/adjustment together with a distance between the sweet spot and the respective loudspeaker, see r_ref. Thus, the delay processing is performed, so that the listener position becomes a sweet spot relative to the set of loudspeakers in an acoustic or perceptual sense.

FIG. 9d shows that for each loudspeaker, a distance 44 of the listener position to a position of the respective loudspeaker may be determined and, based on the distance 44, the delay, see delay0 [i], for the respective loudspeaker may be determined.

As can be seen in FIG. 9d, for each loudspeaker a separate delay, e.g., an absolute delay, is determined, see the index i of the delay variable delay0. Alternatively, the delay processing may determine a reference loudspeaker among the set of loudspeakers and determine the delays of the loudspeakers other than the reference loudspeaker relative to the delay determined for the reference loudspeaker.

An overhead can be used, determined by OVERHEAD_GAIN, see FIG. 9e. That is, this system can amplify signals, when a listener is far away from a loudspeaker up to a factor of 1/OVERHEAD_GAIN. Should the gains supersede this value, then all gains across the channels are scaled with the same factor such that the largest gain is 1.0 (0 dB). This corresponds to inter-channel linked limiter action.

Apart from gain adjustment, additionally, or alternatively, a delay adjustment may be performed, so as to reduce artifacts in the audio rendition due to changes in the delays.

According to an embodiment, a control of delay processing may be performed by subjecting a listener's velocity to a clipping or by subjecting a delay to a clipping, wherein the clipping of the delay and the listener's velocity may be controlled based on a maximum allowable listener velocity, see max_m_s. For example, a maximal velocity may be defined, for which nearly no artifacts result in the audio rendition due to changes in the delays due to a too fast change of a position by a listener. FIG. 9f shows a determination of a maximum delay change, see delay_delta, based on a maximum allowable listener velocity. A number of samples the delay is allowed to change from frame to frame is computed as a function of maximum allowed movement velocity max_m_s. The maximum allowed movement velocity max_m_s may correlate with a maximum rate of delay change [v in m/s].

According to an alternative embodiment, a control of delay processing may be performed by subjecting a listener's acceleration to a clipping or by subjecting a temporal rate of change of a delay to a clipping, wherein the clipping of the temporal rate of change of the delay and the listener's acceleration may be controlled based on a maximum allowable listener acceleration, see max_m_s_s. For example, a maximal acceleration may be defined, for which nearly no artifacts result in the audio rendition due to changes in the delays due to a too fast change of a position by a listener. FIG. 9g shows a determination of a maximum temporal rate of change of the delay, see delay_delta2, based on a maximum allowable listener acceleration. A number of samples the delay change is allowed to change from frame to frame is computed as a function of maximum allowed movement acceleration max_m_s_s. The maximum allowed movement acceleration max_m_s_s may correlate with maximum rate of delay 2nd order change [a in m/s].

The two examples shown in FIGS. 9f and 9g perform the delay processing so that the delays compensate for listener-to-loudspeaker distance variations among the loudspeakers.

Auditory roughness may be mitigated by the following counter-measures:
Updating the VDL by a sample-precision interpolated target delay value (linear interpolation from current value towards target delay value at end of each processing block).
The returned delay value for each output channel is used as target value for an associated variable delay line, which applies the appropriate delay to the corresponding output signal. These output delay lines use the same implementation as the VDLs used in distance rendering within MPEG-I.

Optionally, gains are smoothed with singe-pole averaging, see FIG. 9h. The averaging constant is computed as a function of the smoothing time constant gain_ms.

In case a system or audio processor is already configured to optimize delays and/or gains without considering nearfield and farfield in a reproduction space in which reverberation is effective, it is proposed that the system or audio processor may be configured to calibrate the gain and/or delay adjustment. Calibrated system option cal_system may be used when we are operating on a system which applies already its own optimal gains and delays (and etc.) for the sweet spot. In this case, see FIG. 9i, we are additionally computing the gain and delay compensation of the sweet spot (above, see FIG. 9c, these were computed for the listener position). In this case the difference between the two computations is applied. Beside this differences the compensation gain determination shown in FIG. 9i is based on the same considerations as described with regard to FIG. 9c (same features have been indicated by the same reference numerals).

### Audio Processing

For example, after rendering_gd_updatecfg has been called, the function rendering_gd_process is called, specifying the input and output buffers, see FIG. 10a.

Optionally, the gains are applied with single-pole averaging, see FIG. 10b. For example, a herein described audio processor 10 may be configured to perform a gain adjustment so as to determine, based on a listener position, gains 41. This gain adjustment may be performed by considering a target value, see gain0[ch]. The target value may represent a maximum allowable compensation gain, e.g., determinable using a herein described roll-off gain compensation function, see FIGS. 5, 9c and 9i. A current gain 41a, e.g. a gain determined for a respective loudspeaker without considering that sound energy decays differently in a nearfield and a farfield of the respective loudspeaker, is adjusted with a limited change per time unit, i.e. per sample, towards the target value, i.e. gain0[ch]. At a determination of the target value the different sound energy decay in the nearfield and the farfield of the respective loudspeaker is considered. This prevents artefacts, as the gain changes only slightly per sample. The target value limits the gain change and prevents a too fast or erroneous gain change due to an irregular or too fast change of a listener position.

According to an embodiment, delays may be computed for external delay lines, see FIG. 10c. The delay change per frame, and/or 2nd order delay change per frame is limited, to reduce artefacts and pitch-shifting. For example, a herein described audio processor 10 may be configured to perform a delay processing so as to determine, based on a listener position, delays 51. This delay processing may be performed by considering a target value, see delay0[ch]. The target value may represent a delay for the respective loudspeaker without boundary conditions, e.g. a delay for the actual current listener position, e.g., without considering that an irregular or too fast change of a listener position may have occurred.

The target value may be determined as described with regard to FIG. 9d. The delay determined at the delay processing for the respective loudspeaker may be smoothed. For example, the audio processor may be configured to perform at the delay processing a smoothing by determining a smooth transition from a delay (see reference numeral 51a) determined for the respective loudspeaker for a previous frame, i.e. for a frame preceding a current frame, to a delay for a current frame, e.g., to the target value. A smoothed delay, see reference numeral 51, is calculated, assuming that the speed and acceleration of the listener must not exceed certain values, see the consideration of delay_delta at the limitation of the delay change and/or the consideration of delay_delta2 at the limitation of the delay change second order. It may not be necessary to consider both limitations, but artefacts may be reduced more efficiently, if considering both limitations. The variable delay_delta represents the maximum number of samples the delay is allowed to change from frame to frame and may be determined as described with regard to FIG. 9f. The variable delay_delta2 represents the maximum number of samples the delay change is allowed to change from frame to frame and may be determined as described with regard to FIG. 9g. With this the maximum rate of delay change and/or the maximum rate of delay 2nd order change is limited for the purpose of minimizing artefacts.

The returned delay value for each output channel is used as target value for an associated variable delay line, which applies the appropriate delay to the corresponding output signal. These output delay lines use the same implementation as the VDLs.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] “Adaptively Adjusting the Stereophonic Sweet Spot to the Listener's Position”, Sebastian Merchel and Stephan Groth, J. Audio Eng. Soc., Vol. 58, No. 10, October 2010
[2] “AUDIO PROCESSOR, SYSTEM, METHOD AND COMPUTER PROGRAM FOR AUDIO RENDERING”, WO 2018/202324 A1
[3] https://www.princeton.edu/3D3A/PureStereo/Pure_Stereo.html

1. Audio processor for performing audio rendering by generating rendering parameters, which determine a derivation of loudspeaker signals to be reproduced by a set of loudspeakers from an audio signal, configured to
perform a delay processing so as to determine, based on a listener position, delays for generating the loudspeaker signals for the loudspeakers from the audio signal,
wherein the audio processor is configured to control the delay processing by modifying a version of the listener position, based on which the delay processing is commenced, or any intermediate value determined by the delay processing based on the listener position so as to reduce artifacts in the audio rendition due to changes in the delays.

2. Audio processor according to claim 1, wherein the audio processor is configured to perform the control of the delay processing by
subjecting
one or more of
the listener position,
a listener's velocity,
the listener's velocity towards one or more of the set of loudspeakers,
a listener's acceleration,
the listener's acceleration towards one or more of the set of loudspeakers,
a distance of the listener position to one or more of the set of loudspeakers,
a temporal rate of change of the distance of the listener position to one or more of the set of loudspeakers,
a change rate of the temporal rate of change of the distance of the listener position to one or more of the set of loudspeakers,
the delay for one or more of the set of loudspeakers,
a temporal rate of change of the delay for one or more of the set of loudspeakers, and
a change rate of the temporal rate of change of the delay for one or more of the set of loudspeakers,
to one or more of
smoothing
clipping, and
scaling with a monotonically increasing function having monotonically decreasing slope.

3. Audio processor according to claim 1, wherein the audio processor is configured to perform the delay processing so that the delays compensate for listener-to-loudspeaker distance variations among the loudspeakers.

4. Audio processor according to claim 1, wherein the audio processor is configured to perform the delay processing so that the listener position becomes a sweet spot relative to the set of loudspeakers in an acoustic or perceptual sense.

5. Audio processor according to claim 1, wherein the audio processor is configured to perform a gain adjustment so as to determine, based on a listener position, gains for generating the loudspeaker signals for the loudspeakers from the audio signal.

6. Audio processor according to claim 1, wherein the audio processor is configured to perform a gain adjustment by using for each loudspeaker, a roll-off gain compensation function for mapping a listener-to-loudspeaker distance of the respective loudspeaker onto a listener-to-loudspeaker-distance compensation gain for the respective loudspeaker.

7. Audio processor according to claim 6, wherein the audio processor is configured to perform the gain adjustment so that the listener position becomes a sweet spot relative to the set of loudspeakers in an acoustic or perceptual sense.

8. Audio processor according to claim 1, wherein the set of loudspeakers are attributed to one or more loudspeaker layers, and the audio processor is configured to
if a desired audio signal's sound source position is between two loudspeaker layers,
apply, for each loudspeaker layer of the two loudspeaker layers, a 2D amplitude panning between the loudspeakers of the respective loudspeaker layer so as to determine for the loudspeakers attributed to the respective loudspeaker layer first panning gains for a rendering of the audio signal by the loudspeakers attributed to the respective loudspeaker layer from a virtual source position corresponding to a projection of a desired audio signal's sound source position onto the respective loudspeaker layer, and
apply an amplitude panning between the virtual sound source positions of the two loudspeaker layers, so as to determine for the loudspeaker layers second panning gains for, when applied in addition to the first panning gains, a rendering of the audio signal by the two loudspeaker layers' loudspeakers from the desired audio signal's sound source position.

9. Audio processor according to claim 1, wherein the set of loudspeakers are attributed to one or more loudspeaker layers, and the audio processor is configured to
if a desired audio signal's sound source position is positioned outside the one or more loudspeaker layers,
apply a 2D amplitude panning between the loudspeakers attributed to a nearest loudspeaker layer which is nearest to the desired audio signal's sound source position among the one or more loudspeaker layers, so as to determine for the loudspeakers of the nearest loudspeaker layer the first panning gains for a rendering of the audio signal by the loudspeakers of the nearest loudspeaker layer from a virtual source position corresponding to a projection of a desired audio signal's sound source position onto the nearest loudspeaker layer, and
apply a further amplitude panning between the loudspeakers attributed to the nearest loudspeaker layer along with a spectral shaping of the audio signal so as to result into a sound rendition by the loudspeakers of the nearest loudspeaker layer which mimics sound from a further virtual source position offset from the nearest loudspeaker layer towards the desired audio signal's sound source position, and
apply an even further amplitude panning between the virtual sound source position and the further virtual sound source position, so as to determine second panning gains for a panning between the virtual sound source position and the further virtual sound source position so as to result into a rendering of the audio signal by the nearest loudspeaker layer's loudspeakers from the desired audio signal's sound source position.

10. Audio processor according to claim 9, wherein the audio processor is configured to perform the spectral shaping of the audio signal using a first equalizing function which mimics a timbre of bottom sound if the desired audio signal's sound source position is positioned below to the one or more loudspeaker layers, and/or perform the spectral shaping of the audio signal using a second equalizing function which mimics a timbre of top sound if the desired audio signal's sound source position is positioned above the one or more loudspeaker layers.

11. Audio processor according to claim 1, wherein the audio processor is configured to
perform the delay processing by determining the delay for each loudspeaker independent from a delay determined for any other loudspeaker of the set of loudspeakers, or
perform the delay processing by determining a reference loudspeaker among the set of loudspeakers and determining the delays of the loudspeakers other than the reference loudspeaker relative to the delay determined for the reference loudspeaker.

12. Audio processor according to claim 1, wherein the audio processor is configured to
perform the delay processing by determining the delay for each loudspeaker independent from a delay determined for any other loudspeaker of the set of loudspeakers so as to acquire an absolute delay for the respective loudspeaker, wherein the audio processor is configured to perform the control of the delay processing by subjecting one or more of
the absolute delay for one or more of the set of loudspeakers,
a temporal rate of change of the absolute delay for one or more of the set of loudspeakers, and
a change rate of the temporal rate of change of the absolute delay for one or more of the set of loudspeakers,
to one or more of
smoothing
clipping, and
scaling with a monotonically increasing function having monotonically decreasing slope.

13. Audio processor according to claim 1, wherein the audio processor is configured to perform the delay processing by determining, for each loudspeaker, a distance of the listener position to a position of the respective loudspeaker and, based on the distance, the delay for the respective loudspeaker.

14. Audio processor according to claim 13, wherein the audio processor is configured to perform the control of the delay processing by
subjecting
one or more of
the distance of the listener position to one or more of the set of loudspeakers, a temporal rate of change of the distance of the listener position to one or more of the set of loudspeakers,
a change rate of the temporal rate of change of the distance of the listener position to one or more of the set of loudspeakers,
to one or more of
smoothing
clipping, and
scaling with a monotonically increasing function having monotonically decreasing slope.

15. Audio processor according to claim 1, wherein the audio processor is configured to control the delay processing depending on control information and perform the modifying depending on the control information.

16. Audio processor according to claim 2, wherein the audio processor is configured to derive from control information one or more of
Information on an intensity of the smoothing,
Information on a clipping threshold for the clipping,
Information on a parametrization of the monotonically increasing function having monotonically decreasing slope.

17. Audio processor according to claim 15, wherein the audio processor is configured to derive the control information from a bitstream.

18. Audio processor according to claim 15, wherein the audio processor is configured to derive the control information from side information of bitstream and to decode the audio signal from the bitstream.

19. Method for audio rendering by generating rendering parameters, which determine a derivation of loudspeaker signals to be reproduced by a set of loudspeakers from an audio signal, the method comprising
performing a delay processing so as to determine, based on a listener position, delays for generating the loudspeaker signals for the loudspeakers from the audio signal,
controlling the delay processing by modifying a version of the listener position, based on which the delay processing is commenced, or any intermediate value determined by the delay processing based on the listener position so as to reduce artifacts in the audio rendition due to changes in the delays.

20. Non-transitory digital storage medium having a computer program stored thereon to perform the method for audio rendering by generating rendering parameters, which determine a derivation of loudspeaker signals to be reproduced by a set of loudspeakers from an audio signal, the method comprising
performing a delay processing so as to determine, based on a listener position, delays for generating the loudspeaker signals for the loudspeakers from the audio signal,
controlling the delay processing by modifying a version of the listener position, based on which the delay processing is commenced, or any intermediate value determined by the delay processing based on the listener position so as to reduce artifacts in the audio rendition due to changes in the delays,
when said computer program is run by a computer.

21. Bitstream (or digital storage medium storing the same) as mentioned in claim 1.
